(19) United States
(12) Patent Application Publication
(10) Pub. No.: US 2006/0149118 A1
(43) Pub. Date: Jul. 6, 2006

(54) Process and plant for the hydrothermal treatment of asbestos and/or asbestos-containing materials in supercritical water

(76) Inventors: Fabio Sigon, Inzago (IT); Alberto Servida, Gorgonzola (IT); Simona Grassi, Inveruno (IT)

Correspondence Address: JACOBSON HOLMAN PLLC, 400 SEVENTH STREET N.W., SUITE 600, WASHINGTON, DC, 20004, US

(21) Appl. No.: 10/562,455

(22) PCT Filed: Jun. 17, 2004
(86) PCT No.: PCT/EP04/06809

§ 371 Date: Dec. 27, 2005

(30) Foreign Application Priority Data
Jun. 25, 2003 (IT) MI2003 A001289

(51) Int. Cl. A62D 3/00

(52) U.S. Cl. 588/312

(57) ABSTRACT

Herein described is a process for the hydrothermal treatment of asbestos and/or materials containing asbestos in supercritical water (Supercritical Water, SCW), that provides for the withdrawal (3) of water from a tank (2), the transformation (5) of the water in supercritical water, the reaction of the supercritical water with asbestos or with material containing asbestos in a suitable environment (8) by means of a hydrolysis process, the cooling (14) of the waste water, the filtering (15) of the waste water, the collection of the waste water in a tank (17). Herein is also described a plant for the treatment of asbestos and/or materials containing asbestos comprising a water tank (2), a withdrawal pump (3) associated to said tank (2), a furnace (4) containing a serpentine coil (5) fed by said withdrawal pump (3) for the transformation of the water in supercritical water and a reactor (8) for the reaction of the supercritical water with asbestos and/or with the material containing asbestos, heat exchange means (14) for cooling the waste water from said furnace (4), and filtering means (15) of the water positioned at the output of said exchange means (14) and collection means (17) of the cooled and filtered waste water.

The present invention refers to a process for the hydrothermal treatment of asbestos and/or asbestos-containing materials in supercritical water and relative production plant.

Numerous hydrate silicates, of various chemical compositions, with microcrystalline structure and a fibrous appearance are grouped under the name of amianthus or asbestos. They are subdivided into two classes:

ANPHIBOLES (hydrate silicates of calcium, iron, sodium and magnesium) of which the following are part

| | |
|---|---|
| CROCIDOLITE (or blue asbestos) | Na₂(Mg,Fe)₇Si₈O₂₂(OH)₂ |
| AMOSITE (or brown asbestos) | (Mg,Fe)₇Si₈O₂₂(OH)₂ |
| Commercial name of the mineral | |
| GRUNERITE and CUMMINGTONITE | |
| ANTOFILLITE | (Mg,Fe)₇Si₈O₂₂(OH)₂ |
| ACTINOLITE | Ca₂(Mg,Fe)₇Si₈O₂₂(OH)₂ |
| TREMOLITE | Ca₂Mg₅Si₈O₂₂(OH)₂ |

SERPENTINE (hydrate silicates of magnesium) of which the following are part

| | |
|---|---|
| CHRYSOTILE (or white asbestos) | Mg₃Si₂O₅(OH)₄ |
| | or 3MgO.2SiO₂.2H₂O |

Asbestos has been used for years in a wide range of industrial applications because of its special characteristics such as low cost, flexibility, sound absorption, and resistance to fire, heat and chemical etching. Among the applications of greater significance we can mention: building materials, (the known “Eternit” contains 15% asbestos in the chrysotile form), the materials used as insulation in railway carriages and in ships, covering for water ducts and air conditioning ducts, anti-friction materials in the linings of brakes in automobiles and railway cars, the yarns for fabrics made for protective garments against fire.

With the Italian regulations the waste materials containing asbestos are classified as toxic-poisonous and the law that prohibits its extraction and import dates back to 1992. At national level their amount is estimated at not less than 15 million tons as asbestos has been generally used together with another material.

Currently there is particular interest in the operations and procedures finalised to recuperation and/or elimination of the asbestos and of the products that contain it. The recuperation interventions, that provide for the removal as well as the discarding of any product containing asbestos that has lost its use designation, that has been abandoned or is scheduled to be abandoned, produce Asbestos-Containing Waste (ACW), that contains a variable quantity of asbestos in the interval (10-100)% on weighted base.

A problem that is common to the recuperation and/or neutralising processes of the ACW materials is that associated to the efficiency of transforming the asbestos in inert products that are not dangerous, that is in materials that no longer can be assimilated to fibres that can be breathed in. In fact, for the purpose of evaluating the fibrous asbestos, whose danger is also linked to the dispersion in air, any elongated thready or needle-like solid object is intended with a length equal to or greater than 5 μm, diameter less than 3 μm and with a length/diameter ratio equal to or greater than 3.

The diameter of a fibre takes on basic importance for the capability of it being breathed in, while the length is not very significant as it is very difficult to breath in the fibres which are longer than 200 μm while the short fibres are eliminated by the clearance of the macrophages.

A recent provision of Italian law (13/03/03) decrees that:

the waste of asbestos or of materials containing asbestos have to be collected in a dump for dangerous waste, specifically or fitted with a specific cell, where thus it undergoes a process of encapsulation in the site, (that is in the cell of the waste dump).

if the ACW materials have been submitted to treatment processes, such as: stabilization, encapsulation, embedding, or chemical-physical-thermal treatment, the decree provides for them to be collected in a dump for non-dangerous waste.

Among the main processes known for the treatment of the ACW materials, only the chemical-physical technologies (Yoshiro et al., U.S. Pat. No. 3,941,184; Block, U.S. Pat. No. 5,753,031; U.S. Pat. No. 5,753,032; U.S. Pat. No. 5,753,033; U.S. Pat. No. 5,753,034; U.S. Pat. No. 5,753,035; and Block et al., U.S. Pat. No. 5,743,841) and thermal technologies (Aspireco, European patent n. 0344563; Italian patent n. 20799-Mi/88) tend to eliminate the potential risk by transforming asbestos in a non-fibrous and non-toxic crystalline phase.

Because of the high costs, the dump is the most common removal process, even though it is less effective as it does not eliminate the asbestos problem, seeing its potential danger remains unaltered.

Over recent years, methods for transforming thready asbestos have been proposed (chrysotile and amosite) in inert materials (U.S. Pat. No. 5,743,841) by means of neutralising the asbestos by etching at a low temperature and pressure. The procedure is based on a etching by acids using a mixture of a strong acid and a kind capable of generating fluorine in the system. The acid has the task of demolishing the structure of the asbestos hydrolysing the MgO groups, while the fluorine should etch the “silicate” component of the asbestos structure.

The interest for these treatments lies in the fact that they can be easily applied on site directly on the manufactured articles containing asbestos (for example, tubes covered with asbestos-based insulation, whose percentage is around 12%), and therefore there are no problems in transporting dangerous material.

The disadvantages of these treatment methods can be summed up as follows:

the use of a dangerous reagent, hydrofluoric acid, that requires suitable measures of prevention and safety to be adopted;

the transformation takes a long time. In fact, the kinetics of the neutralising process by etching depends on two critical factors:

1. the velocity of penetration (imbibition) of the watery solution inside the manufactured article containing asbestos;

2. the wettability characteristics of the manufactured article containing asbestos.

Because of these two critical factors the time needed for neutralising is around days. In fact, as given in Block's patent (U.S. Pat. No. 5,743,841) starting from a acid/chrysotile ratio (cementitious mix with 11.7% content of chrysotile) of 1.5:1, the process is basically completed after two days of treatment; in particular Block shows that from the XRD analyses (X-Ray Diffraction) it results that the residual chrysotile after a day is 0.5%, being reducing to 0.1% after 4 days; the treatment is, substantially, a superficial treatment, because of the problems of penetration of the watery solution inside the porous material to be treated.

The object of the present invention is to provide a treatment procedure and a relative plant that are economically advantageous and that allow the neutralising of asbestos and/or materials containing asbestos and the elimination of the problems associated with the penetration process (imbibition) using a supercritical and oxidising environment (supercritical water, SCW).

In accordance with the present invention this object is achieved by means of a process for the hydrothermal treatment of asbestos and/or materials containing asbestos in supercritical water (Supercritical Water, SCW) characterised in that it provides for the following steps:

withdrawal of water from a tank;

transformation of the water into supercritical water;

reaction of the supercritical water with asbestos and/or with the material containing asbestos in a suitable environment by means of a hydrolysis process;

cooling of the waste water;

filtering of the waste water;

collection of the waste water in a tank.

In accordance with the present invention this object is also achieved by means of a plant for the treatment of asbestos and/or materials containing asbestos characterised in that it comprises a water tank, a withdrawal pump associated with said tank, a furnace containing a serpentine coil fed by said withdrawal pump for the transformation of the water into supercritical water and a reactor for the reaction of the supercritical water with asbestos and/or with the material containing asbestos, heat exchange means for cooling the waste water of said reactor, water filtering means placed at the output of said exchange means and collection means for the cooled and filtered waste water.

The operative conditions are preferably the following:

400° C.<T<750° C.;

22.11 MPa<P<28 MPa.;

hydrolysis time <24 hours.

The environmental, energy and productive advantages that would be obtained with the new hydrothermal treatment of asbestos or of materials containing asbestos in supercritical water are multiple and unquestionable.

The hydrothermal process of hydrolysis can represent an economical and final solution for elimination as, in comparison to the known thermal processes, it presents greater potential in reducing the costs of treatment for the “low” working temperatures and the possibility of carrying out effective energy recuperation in the process. The advantages and benefits can thus be summed up as follows:

the better solvent properties of the water in supercritical conditions improve the wettability characteristics of the solid materials of asbestos or materials containing asbestos accelerating the penetration processes of the “reagent” fluid. All this leads to a marked increase in the kinetics of the neutralising process;

the treatment procedure allows work to be carried out in a limited environment, reducing the risk of emission into the environment to a minimum. It is a zero emission process;

in comparison to other processes based on etching, the absence of chemical reagents or other substances with high environmental impact (for example, strong acids and hydrofluoric acid) make the process particularly advantageous both from the point of view of the safety of execution and from the point of view of the impact on the environment. It is a process that can be ecologically supported;

the process is characterised by low energy consumption in that effective energy recuperation can be made;

the not particularly aggressive working environment from the chemical point of view places minor restrictions on the choice of the plant building materials thus contributing to the reduction of the fixed plant costs;

the complete neutralising of asbestos and ACW waste;

greater flexibility in executing the process;

significant reduction in the volume of the waste whether it be asbestos or ACW material;

the possibility of making both asbestos and ACW materials inert definitively with a single process, obtaining an inert product with a certain market value: forsterite.

The innovative process object of the present invention provides for operating at relatively low temperatures (400-750° C.) against the 900° C. and over of the traditional thermal treatments, at relatively high pressures (22-28 MPa).

The hydrolysis time, and thus the duration of the transformation process, to obtain a final product without any toxic-noxious residual is less than 24 hours according to the operative conditions chosen. This is a relatively brief time if compared with the contact time proposed by other alternative neutralising processes (both thermal and chemical) that provide for more than 24 hours of work.

Another strong point of the invention is that fact that, differently from other chemical treatments, the hydrothermal process of hydrolysis in supercritical water does not require the use of any chemical reagent or substance with a high impact on the environment. In fact, the water or the hydrogen peroxide represents the only “reagent” needed for the neutralising procedure.

The process presents the big advantage of containing and preventing the dispersion of the materials treated (asbestos or ACW) in the environment. Being very compact, the process can be carried out as a fixed plant or as a mobile plant; in the latter case there would be the advantage of not having to transport the dangerous waste but the neutralising could be carried out directly on the site.

The energy advantages that are obtained by using supercritical water are enormous, as efficient thermal recuperation can be provided for in the process that allows a significant lowering of the operative costs.

In comparison to the noise level of a normal thermal process with a conventional furnace, thanks to the absence of burners and comburent air fans, the sound emissions are almost totally absent.

Another strong point of the neutralising process proposed is the possibility of resolving definitively, safely and not temporarily the disposal of asbestos and of ACW waste, differently from that obtained instead by dumping. In addition, the possibility of avoiding disposal by dumping would avoid the construction of new special dumps that are more and more difficult to create with a consequent saving on costs for the community.

The validity and efficiency of the new process has been shown, for the first time, also for ACW waste with high concentrations of asbestos (fire-proof covering of asbestos-chrysotile). As the process is very simple it can be applied industrially with massive significant quantities of ACW.

These and other characteristics of the present invention will be made even more evident from the following detailed description of an embodiment thereof illustrated as non-limiting example in the enclosed drawings, in which:

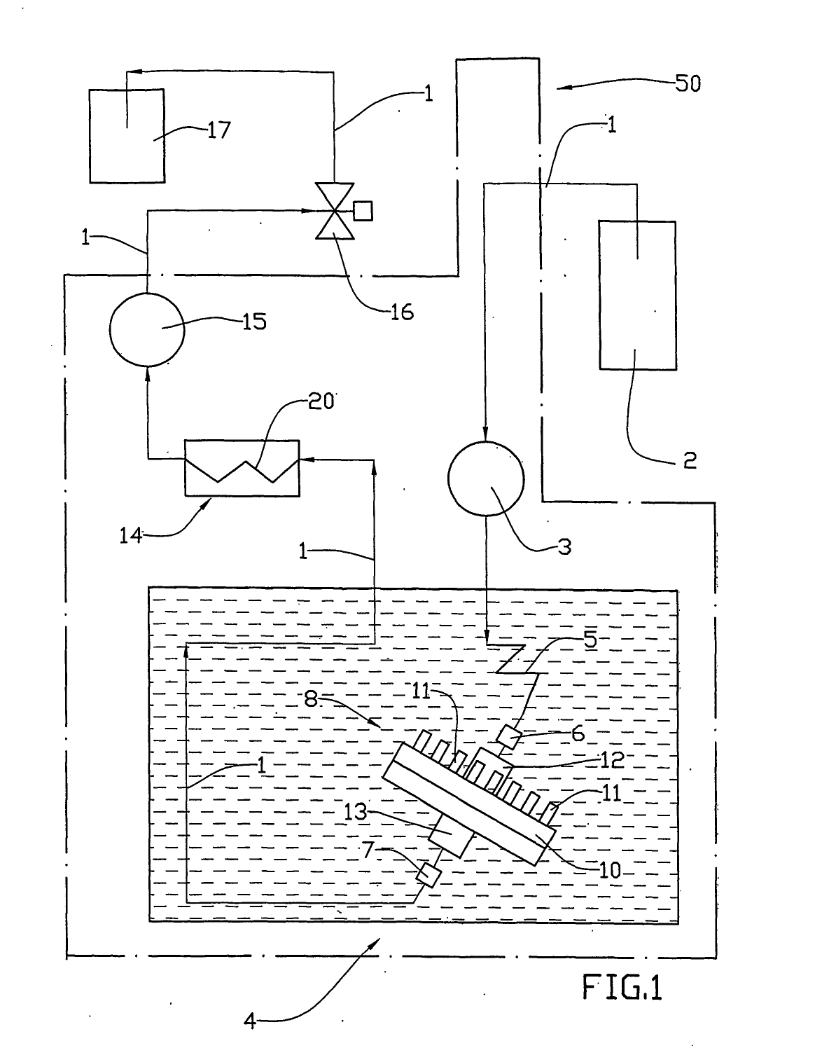

FIG. 1 shows the diagram of a plant according to the present invention;

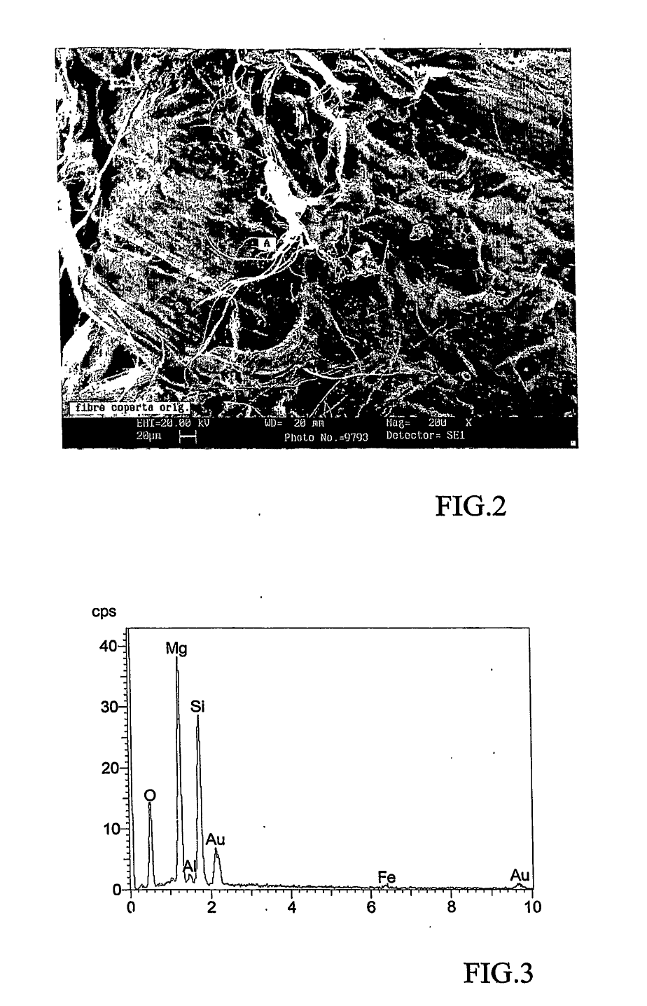

FIG. 2 shows an image produced with the SEM technique (Scanning Electron Microscopy) of a sample of asbestos containing fibrous chrysotile;

FIG. 3 shows a spectrum produced with the EDS technique (Energy Dispersive Spectrum) of the sample of asbestos of FIG. 2;

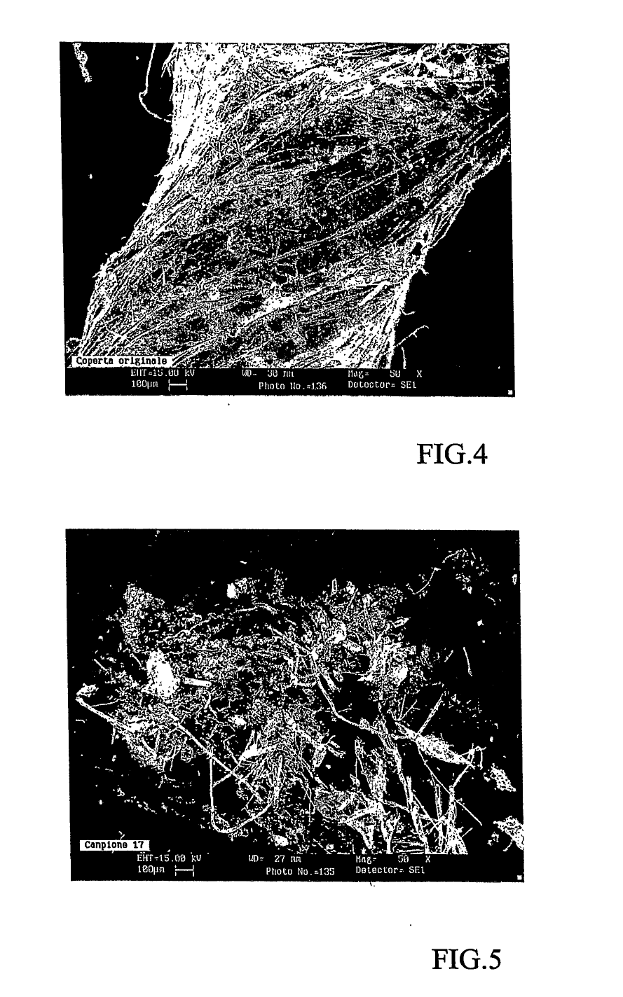

FIG. 4 shows an enlarged image (50×) with SEM technique of the sample of asbestos before the hydrothermal treatment according to the present invention;

FIG. 5 shows an enlarged image (50×) with SEM technique of the sample of asbestos of FIG. 4 after the hydrothermal treatment according to the present invention;

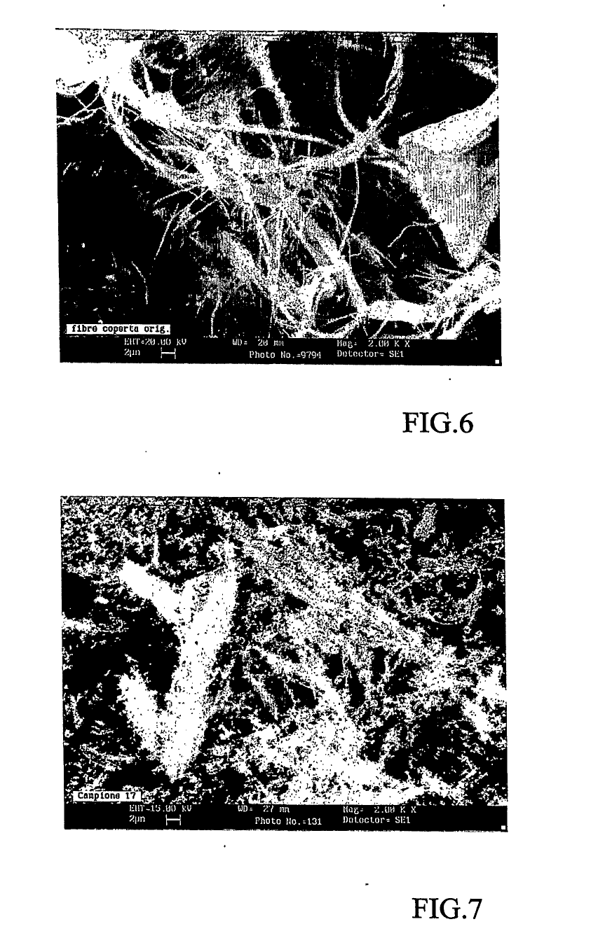

FIG. 6 shows an enlarged image (2000×) with SEM technique of the sample of asbestos before the hydrothermal treatment according to the present invention;

FIG. 7 shows an enlarged image (2000×) with SEM technique of the sample of asbestos of FIG. 4 after the hydrothermal treatment according to the present invention;

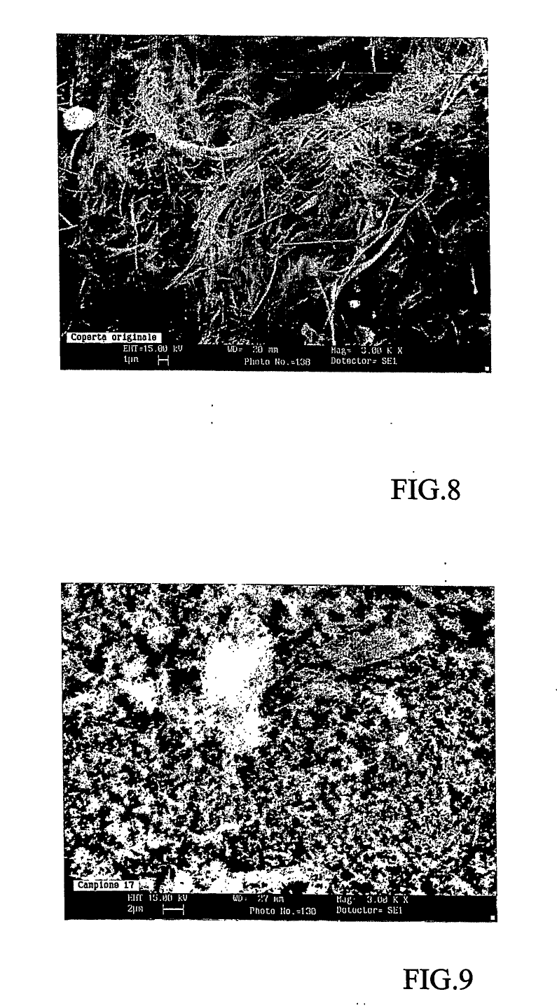

FIG. 8 shows an enlarged image (3000×) with SEM technique of the sample of asbestos before the hydrothermal treatment according to the present invention;

FIG. 9 shows an enlarged image (3000×) with SEM technique of the sample of asbestos of FIG. 4 after the hydrothermal treatment according to the present invention;

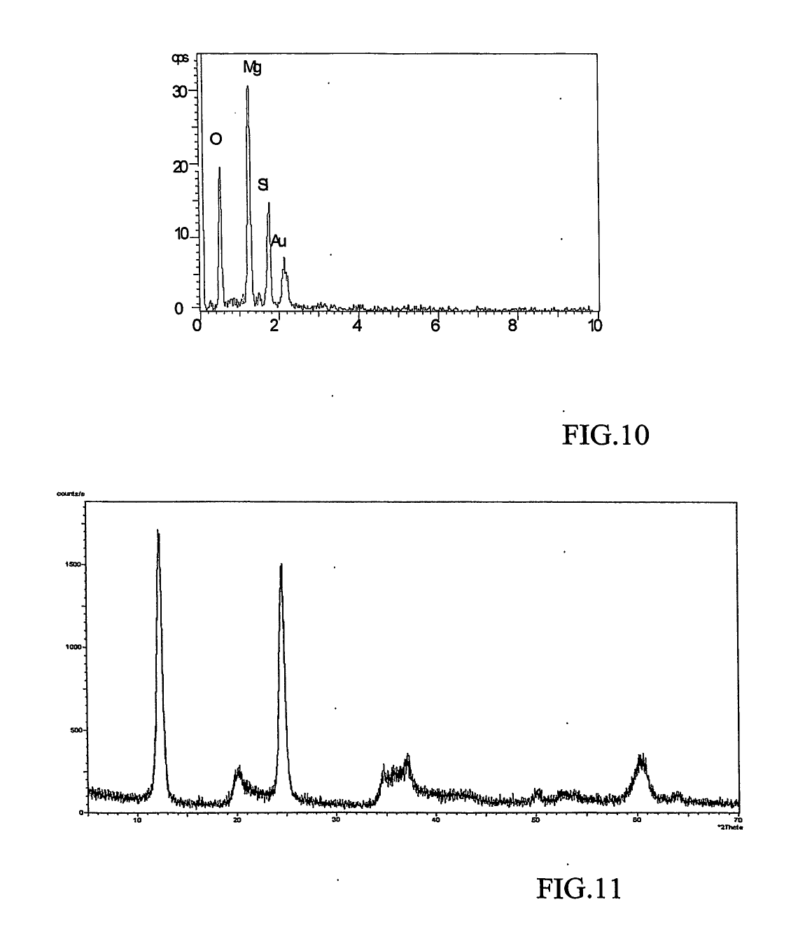

FIG. 10 shows a spectrum produced with EDS technique of the sample of asbestos of FIG. 4 after the hydrothermal treatment according to the present invention;

FIG. 11 shows a spectrum produced with XRD technique (X-Ray Diffraction) of the sample of asbestos before the hydrothermal treatment according to the present invention;

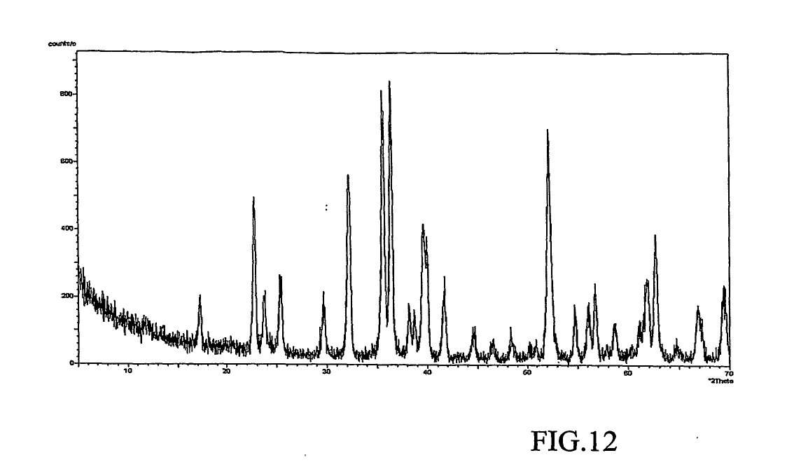

FIG. 12 shows a spectrum produced with XRD technique of the sample of asbestos after the hydrothermal treatment according to the present invention.

A plant for a hydrothermal treatment of materials containing asbestos (FIG. 1) comprises conduits 1 and a tank 2 containing distilled water, which is withdrawn from here by means of a pump 3 and conveyed to a fluidised bed electric furnace 4.

Said electric furnace 4 contains a part of the conduits 1, a preheating serpentine coil 5 and control sensors 6-7 upstream and downstream of an extractable reactor (water storage tank) 8, that is made up of two cylindrical bodies 10 held together, along the external edge, by means of bolts 111 and in the centre a cylindrical input opening 12. In the lower part of the body 10 there is a cylindrical output opening 13.

Downstream from the electric furnace 4 there is a cooling exchanger 14 with a serpentine coil 20, a filter 15 and an adjustment valve 16, that regulates the pressure of the water which, at the end of the hydrothermal process according to the present invention, finishes in a collection tank 17.

All the abovementioned components of the plant, except for the tanks 2 and 17 and the valve 16, are preferably inserted in a confined closed environment 50, so as to reduce the risk of emission into the air as much as possible.

In the operation, which can come about both in the continuous modality and in the discontinuous modality or even “semi-batch” (that is with water in the continuous modality and solid material in the discontinuous modality), the pump 3 withdraws distilled water from the tank 2 and conveys it into the electric furnace 4 through conduits 1. By means of the preheating serpentine coil 5 the water is conveyed in supercritical conditions (T=680° C. about, P=27 MPa) detected by the sensor 6. The pressure is regulated by the valve 16.

The water in supercritical conditions enters through the opening 12 into the reactor 8 loaded with asbestos or ACW material.

Said supercritical water, in contact with the asbestos or the ACW material for 3 hours, penetrates the braided bands of the asbestos (FIGS. 2, 4, 6 and 8), determines a hydrolysis process that separates the fibres from each other, degrades the silicon chrysotile (SiO₂), that becomes a solution, and modifies the structure with fibrous morphology into crystals of forsterite (FIGS. 5, 7 and 9).

The reaction that comes about can be represented by the following stoichiometry:
2*[Mg₃Si₂O₅(OH)₄]===>3*[Mg₂SiO₄]+[SiO₂]_{aq}+4*[H₂O]

When the reaction has finished the supercritical water leaves the reactor 8 and the furnace 4 to go and cool down to an ambient temperature in the exchanger 14.

Thanks to the filter 15 any solid materials present (asbestos or ACW) carried along are held, so that the water finishes in the collection tank 17 simply enriched with SiO₂ and other salts, for example MgO.

Herein below, as proof of the effectiveness of the invention, the results relating to a test carried out in the following operative conditions are given:

the flow of the solution entering was set at 7.5° C./min;

0.15 gr of pure chrysotile were used (sample of a fireproof covering);

the temperature of the furnace 4 was regulated so as to guarantee an operating temperature of the water storage tank 8 of 680° C.;

the micrometric valve 16 was regulated to guarantee an operating pressure of 27 MPa;

the test was carried out using a hydrolysis time of 3 hours.

The morphology of the fibrous bodies was characterised using the SEM technique, which, because of its high resolutive power, allows the detection of even the smallest dimensioned fibres. The chemical analysis (quality/quantity) of the elements was also carried out using an X-ray microprobe. The analysis of the solid residue was carried out by means of RX diffractometry. The watery solution collected in output from the reactor was analysed with the Icp plasma technique.

The solid extracted from the reactor after the hydrothermal hydrolysis treatment in supercritical water was weighed finding a loss in weight equalling 25%. The analyses made on the filtering cartridge revealed total absence of solid material, which proves that the loss in weight found was due to the hydrolysis process. The solid collected by the water storage tank 8 was characterised with the techniques SEM, EDS and XRD.

FIG. 2 shows a SEM image, while FIG. 3 shows the relative spectrum EDS of the sample of original chrysotile.

In the following Figures the SEM photos at various enlargements are given, 50× (FIGS. 4-5), 2000× (FIGS. 6-7) and 3000× (FIGS. 8-9), of the sample of asbestos before (FIGS. 4, 6 and 8) and after the hydrothermal hydrolysis treatment in supercritical water (FIGS. 5, 7 and 9).

The SEM photos taken at the highest resolutions (2000-3000×) of the sample treated (FIGS. 7 and 9) show that, by effect of the treatment, the fibrous-needle-like morphology with length equal to or greater than 5 μm and diameter less than 3 μm, responsible for the toxicity of the original material, has been completely transformed. In fact, no fibre whatsoever is visible in the solid and thus it can be concluded that the hydrothermal hydrolysis process in supercritical water has allowed the original fibrous asbestos to be transformed into a non-fibrous and non-toxic phase. The EDS analysis, shown in FIG. 10 was carried out on the solid. The ratio between the height of the peaks of the Mg and those of the Si are significantly different before (FIG. 3) and after the treatment (FIG. 10). Before the treatment the ratio of the heights Mg/Si is equal to 1.3, this means that the height of the peak of the Mg in the chrysotile is just over that of the peak of the Si; while in the spectrum of the sample treated the same ratio equals 2.1; this means that the spectrum of FIG. 10 is not representative of the chrysotile. This conclusion is also supported by the fact that the spectrum of FIG. 10 indicates the complete absence of iron, another characteristic chemical element, even though present in a small concentration in chrysotile.

After the treatment RX diffractometric analyses were conducted to highlight the presence of crystalline substances and their nature. FIGS. 11 and 12 show the two spectrums of the sample before (FIG. 11) and after the treatment (FIG. 12). Both spectrums reveal that inside the solid material there is a monocrystalline phase. While the spectrum of FIG. 11 is characteristic of the chrysotile, that of FIG. 12 is characteristic of the forsterite.

In the sample hydrolysed with supercritical water and analysed with the XRD technique the presence of chrysotile was not detected, which, if present, was in concentrations that are lower than the limit of detection of the instrument. The total absence of fibres, that demonstrates the effectiveness of the innovative treatment proposed, was demonstrated by the SEM, which, also at greater resolutions did not highlight the presence of fibrous solid.

To make the process more effective and attractive, the asbestos and/or the material containing asbestos can be given a wet pretreatment. In particular said asbestos and/or material containing asbestos can be broken up and ground in the presence of water, with or without additive, until it reaches a preset consistence (for example from 20% to 30% solid part), then it is loaded into the reactor.

In this manner dispersion of asbestos fibre in the working environment and the inconvenience of working with anhydrous material or however with humidity lower than 10-20% are avoided, which are typical conditions of thermal treatments of ACW materials.

To treat materials containing asbestos with organic matrix an oxidising environment of supercritical water can be used for operation.

Finally it can be noted that the process and the plant described above in relation to asbestos and to materials containing asbestos must be considered conceptually valid and also applicable to any other material with similar characteristics, in particular for neutralising any potentially dangerous material with fibrous morphology.

1. Process for the hydrothermal treatment of asbestos and/or materials containing asbestos in supercritical water (Supercritical Water, SCW) characterised in that in succession they provide for the following steps:
withdrawal (3) of water from a tank (2);
transformation (5) of the water in supercritical water;
reaction of the supercritical water with asbestos and/or with the material containing asbestos in a suitable environment (8) by means of a hydrolysis process;
cooling (14) of the waste water;
filtering (15) of the waste water;
collection of the waste water in a tank (17).

2. Process according to claim 1, characterised in that said water is distilled.

3. Process according to claim 1, characterised in that said water is oxygenate.

4. Process according to claim 1, characterised in that it is produced in a confined environment.

5. Process according to claim 1, characterised in that it is carried out in continuous modality.

6. Process according to claim 1, characterised in that it is carried out in discontinuous modality.

7. Process according to claim 1, characterised in that it is carried out in semi-batch modality, that is with water in continuous modality and solid material in discontinuous modality.

8. Process according to claim 1, characterised in that it is carried out in the following conditions of temperature T, pressure P and hydrolysis time:
400° C.<T<750° C.;
22.11 MPa<P<28 MPa.;
hydrolysis time <24 hours.

9. Process according to claim 1, characterised in that, before the reaction with the supercritical water, the asbestos and/or the material containing asbestos is submitted to a wet pretreatment.

10. Process according to claim 9, characterised in that said wet pretreatment provides for the breaking up and grinding of the asbestos and/or of the material containing asbestos in the presence of water.

11. Process according to claim 9, characterised in that said pretreatment comes about with additives.

12. Plant for the treatment of asbestos and/or materials containing asbestos characterised in that it comprises a water tank (2), a withdrawal pump (3) associated to said tank (2), a furnace (4) containing a serpentine coil (5) fed by said withdrawal pump (3) for the transformation of the water in supercritical water and a reactor (8) for the reaction of the supercritical water with asbestos and/or with the material containing asbestos, heat exchange means (14) for cooling the waste water of said reactor (8), and means for filtering (15) the water positioned at the output of said exchange means (14) collection means (17) of the cooled and filtered waste water.

13. Plant according to claim 12, characterised in that said water is distilled.

14. Plant according to claim 12, characterised in that said water is oxygenated.

15. Plant according to claim 12, characterised in that it is in a confined environment.

16. Plant according to claim 12, characterised in that the reactor (8) is made to function with the following values of temperature T, of pressure P and hydrolysis time:
400° C.<T<750° C.;
22.11 MPa<P<28 MPa.;
hydrolysis time <24 hours.

17. Plant according to claim 12, characterised in that the furnace (4) is electric.

18. Plant according to claim 12, characterised in that said furnace (4) is a fluidised bed.

19. Plant according to claim 12, characterised in that said reactor (8) is a water storage tank.

20. Plant according to claim 12, characterised in that said reactor (8) can be extracted from the furnace (4).

21. Plant according to claim 12, characterised in that said exchangers (14) have a serpentine coil.

22. Plant according to claim 12, characterised in that it comprises an adjustment valve (16) inserted downstream from said heat exchange means (14).
